(19) United States
(12) Patent Application Publication
(10) Pub. No.: US 2007/0103834 A1
(43) Pub. Date: May 10, 2007

(54) CIRCUIT FOR CHARGING PROTECTION WITH ENHANCED OVERCURRENT PROTECTION CIRCUITRY

(76) Inventors: Chun-Wei Huang, Taipei Hsien (TW); Chien-Tang Lin, Taipei City (TW); Shun-Chuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/556,701

(22) Filed: Nov. 5, 2006

(30) Foreign Application Priority Data
Nov. 7, 2005 (TW) 094138976

(51) Int. Cl. H02H 5/04

(52) U.S. Cl. 361/104

(57) ABSTRACT

A charging protection circuit with an overcurrent protector circuit takes input from a power supply, and provides output power to a power storage device, such as a battery. A fuse is connected between an input and an output of the charging protection circuit to protect the power storage device from a current spike, or overcurrent, that would damage the power storage device. When the overcurrent is above a threshold of the fuse, the fuse melts, effectively creating an open circuit and blocking the overcurrent from reaching the power storage device. To speed up the fuse meltdown, the overcurrent protector circuit is connected to the output of the fuse, and draws an extra current through the fuse when the overcurrent is detected.

### BACKGROUND OF THE INVENTION

1. Field of the Invention

The present invention relates to a charging protection circuit, and more specifically, to a charging protection circuit with a circuit-level enhanced overcurrent protection mechanism.

2. Description of the Prior Art

With the development and progress of electronic technologies, the size and weight of electronic devices such as mobile phones, personal digital assistants (PDA), digital cameras, portable media players, portable computers, and so on, have been greatly reduced, making them easily portable. Most of these portable devices are powered by batteries, and therefore battery chargers are essential to keeping these devices functioning. One example of such a charger is a mobile phone charging base, which converts alternating current (AC) into direct current (DC) for charging the batteries.

In the charging process, however, the charging devices may malfunction, or short-circuit, for many reasons, such as rust in a conducting metal, charging an out-of-spec battery, alternating the polarity of the battery, damaged battery circuits, and so forth. The malfunction or short circuit pulls a large current from the power supply, and the excess charge current can damage the battery and even cause an explosion that destroys the device and could harm users.

The prior art teaches some overcurrent protection mechanisms in the mobile phone charging process which are realized through a fuse that prevents the danger of malfunction or short-circuit in the battery. In these techniques, the fuses are installed in the charger and coupled to the power supply and the battery so as to conduct the charging current. When the charging current exceeds a predetermined value, the fuses melt down and the batteries are disconnected from the power supply. Other techniques are also available, most of which employ software-controlled protection mechanisms in the mobile phone. For instance, some specific software may be loaded into a processor of the mobile phone to monitor current and voltage values during the charging process.

Nevertheless, there are disadvantages to the above techniques. One of the main drawbacks is that it takes time to melt down the fuse and to disconnect the batteries from the power supply when the charging current exceeds the predetermined value. The batteries are still charged with the excess current before the fuse disconnects, and the damage caused by the malfunction or the short-circuit is not avoided. Furthermore, modern electronic devices usually operate at low voltages to conserve power, such that the maximum tolerable current is consequently lower than in higher voltage topologies. In this situation, the charging current might exceed the maximum tolerable current, but may not melt the fuse and engage the overcurrent protection mechanism. As for software-based protection mechanisms, there are more high-level operations involved, so that the reliability and response time are still unsatisfactory. In other words, the prior art overcurrent protection mechanisms are not sensitive or responsive enough to adequately protect the battery being charged.

### SUMMARY OF THE INVENTION

It is therefore an objective of the present invention to provide a charging protection circuit with an overcurrent protection circuit to address the above-mentioned problems. The charging protection circuit comprises a fuse, an output and an overcurrent protector. The fuse has a first end and a second end. The first end of the fuse is coupled to a power supply. The second end of the fuse is connected to the output end, which outputs a current transmitted from the second end of the fuse. The overcurrent protector is coupled to the second end of the fuse to increase the current flowing through the fuse, and thus speed up meltdown of the fuse, when the current transmitted from the second end of the fuse is greater than a predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a charging protection circuit of the present invention.

FIG. 2 is an electronic circuit connection diagram of the charging protection circuit of the present invention.

FIG. 3 is a graph illustrating a current-voltage characteristic when the charging protection circuit of the present invention performs an overvoltage protection.

FIG. 4 is a graph illustrating a current-voltage characteristic when the charging protection circuit of the present invention performs an overcurrent protection.

FIG. 5 is a diagram of the charging protection circuit of the present invention as utilized in an electronic device.

### DETAILED DESCRIPTION

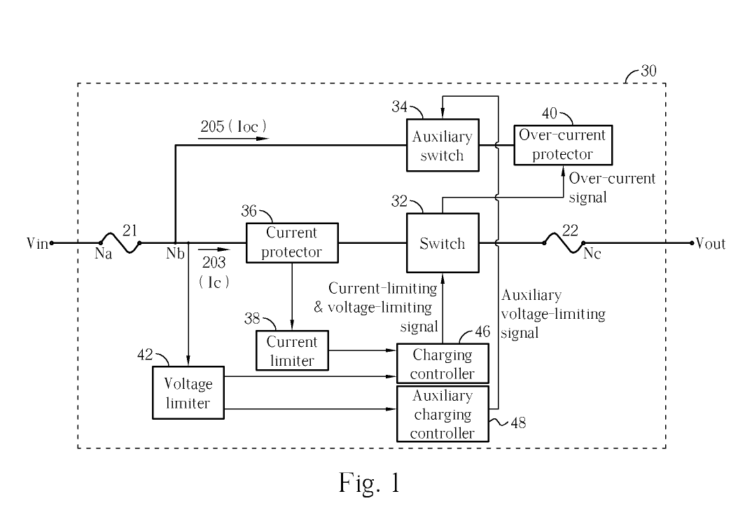

Please refer to FIG. 1. FIG. 1 is a diagram of a charging protection circuit 30. The charging protection circuit 30 comprises a fuse 21, a current detector 36, a switch 32, an auxiliary fuse 22, a current limiter 38, a charging controller 46, an auxiliary switch 34, an overcurrent protector 40, a voltage limiter 42, and an auxiliary charging controller 48. The first end of the fuse 20 is connected to a node Na and receives a current from a power supply. The second end of the fuse is connected to a node Nb, a branch 203, and a branch 205, and transmits the current from the power supply. The current detector 36, the switch 32, and the auxiliary fuse 22 are coupled at the branch 203. A charging current Ic flows through the branch 203 and the charging current is output to the battery at a node Nc, namely the output end of the charging protection circuit 30.

The switch 32 is used to control the charging current Ic. The current detector 36 measures the magnitude of the charging current Ic. The current limiter 38 amplifies the measurement from the current detector 36 to the charging controller 46. The charging controller 46 then controls the switch 32 by a voltage according to the amplified measurement. When the charging current Ic approaches a predetermined value, the current limiter 38 amplifies the signal from the current detector 36 and transmits the signal to the charging controller 46. The charging controller 46 makes the switch 32 clamp the charging current Ic. The interoperation of the current detector 36, the current limiter 38, the charging controller 46, and the switch 32 achieves current-limiting protection.

The magnitude of the current flowing through the switch 32 serves as an overcurrent signal for controlling the overcurrent protector 40. The auxiliary switch 34 is used to control the overcurrent protector 40 based on the overcurrent signal from the switch 32 for conducting an auxiliary current loc over the branch 205. When the charging current Ic is under the predetermined value, the overcurrent protector 40 does not conduct the auxiliary current loc. The whole charging current goes through the fuse 21 and the branch 203 to the node Nc of the output end. However, when the magnitude of the charging current Ic on the branch 203 approaches or exceeds the predetermined value, the switch 32 decreases the output current based on the amplified measurement transferred from the current limiter 38 and the charging controller 46 to realize the current-limiting protection.

The higher the current flows over the branch 203, the more the switch 32 decreases the output current. When the charging current Ic exceeds the predetermined value, the overcurrent protector starts to conduct the auxiliary current loc. As shown in FIG. 1, the conduction of loc increases the current load of the fuse 21 in order to burn down the fuse when the current at the second end of the fuse is greater than the predetermined value, and melts down the fuse 21 to accelerate disconnection of the batteries from the power supply. The overcurrent protection is thus achieved.

From the above description, the charging protection circuit 30 can rapidly burn down the fuse 21 by conducting an auxiliary current loc through the overcurrent protector 40. Therefore, we can adjust the sensitivity and response time of the overcurrent protection mechanism by modifying the design parameters. For example, we can speed up the time for melting down the fuse by increasing the current conducted through the overcurrent protector 40.

Furthermore, additional overcurrent protection is realized by adopting an auxiliary fuse 22. The auxiliary fuse 22 can be thermo-coupled with the switch 32 in the circuit layout. The switch 32 heats up to melt down the auxiliary fuse 22 when current flowing through the switch 32 exceeds the predetermined value.

In addition to current limiting and overcurrent protection, the charging protection circuit 30 further provides an overvoltage protection through a voltage limiter 42. The voltage limiter 42 detects the voltage at the node Nb and signals the charging controller 46 and the auxiliary charging controller 48 to control the switch 32 and the auxiliary switch 34, respectively. When the voltage at the node Nb exceeds a predetermined value, the voltage limiter 43 makes the charging controller 46 turn off the switch 32 to disconnect the branch 203 and causes the auxiliary charging controller 48 to turn off the auxiliary switch 34 to disconnect the branch 205. Therefore, overvoltage protection is accomplished.

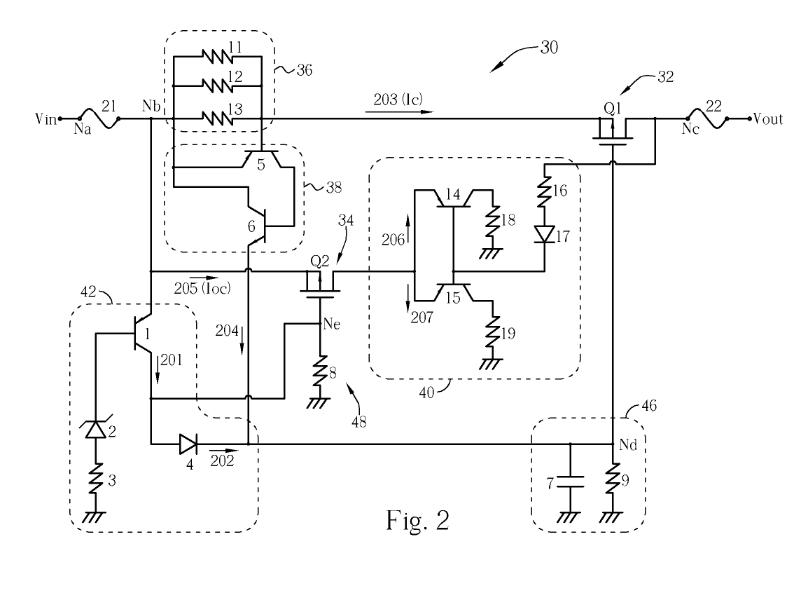

Please refer to FIG. 1 and FIG. 2. FIG. 2 is an exemplificative circuit implementation according to the present invention in FIG. 1. As shown in FIG. 2, the current detector 36 includes one or several resistors connected in parallel. Because the current detector is connected in series with the branch 203, if one resistor does not draw sufficient current in the current detector 36, further resistors can be connected in parallel to increase the maximum current through the current detector 36, such as the configuration shown in FIG. 2. The current limiter 38 can be realized with two bipolar junction transistors (BJTs) 5 and 6. The base-emitter voltage of the BJT 5 is controlled by the current detector 36. The BJT 6 amplifies the collector current of the BJT 5 and transmits the amplified current to the charging controller 46 via a branch 204. The charging controller 46 can be realized with a capacitor 7 and a resistor 9, and the voltage at a node Nd serves as the current-limiting or voltage-limiting signal. The switch 32 can be realized as a Metal-Oxide-Semiconductor (MOS) transistor Q1 with the source and the drain coupled to the branch 203. The gate of MOS transistor Q1 is coupled to the node Nd to adjust the conduction current according to the signal from the charging controller 46. In addition, the MOS transistor Q1 can be thermo-coupled with the auxiliary fuse 22 for additional overcurrent protection.

On the branch 205, the overcurrent protector 40 can by realized by one or several controlled current sources. As shown in FIG. 2, the overcurrent protector 40 comprises two controlled current sources, wherein one is formed by a BJT 14 and a resistor 18 and the other is formed by a BJT 15 and a resistor 19. The sum of the controlled current sources is equal to the auxiliary current loc. The bases of the BJTs in the controlled current sources are coupled to the drain of the MOS transistor Q1 with a diode 17 and a resistor 16. The drain voltage of the MOS transistor Q1 serves as the overcurrent signal to control the conduction of the controlled current sources. The auxiliary switch 34 can be realized with a MOS transistor Q2 with a gate controlled by the auxiliary charging controller 48, which can be realized with a resistor 8. The voltage at a node Ne is the auxiliary voltage-limiting signal.

The voltage limiter 42 can be implemented with a BJT transistor 1, a Zener diode 2, and a resistor 3. The base of the BJT transistor 1 is coupled to the Zener diode 2 and the resistor 3. The emitter of the BJT transistor 1 is coupled to the node Nb and the collector of the BJT transistor 1 is coupled to the node Ne for generating the auxiliary voltage-limiting signal with the auxiliary charging controller 48. The collector of the BJT transistor 1 is further coupled to the node Nd with a diode 4 for generating a voltage-limiting signal with the charging controller 46. Because the current limiter 38 is coupled to the node Nd, the diode 4 can also prevent the current in the branch 204 from flowing to the voltage limiter 42.

The operation of the circuit in FIG. 2 can be described as follows. The charging current Ic generates a voltage across the current detector 36, which is the base-emitter voltage of the transistor 5. Therefore, the charging current Ic effectively controls the magnitude of the current flowing through the transistor 5. The current flowing through the collector and the emitter of the transistor 5 is amplified by the transistor 6 and transmitted to the charging controller 46 to generate a current-limiting signal at the node Nd and further control the switch 32. Therefore, when the charging current Ic increases, the voltage across the current detector 36 increases, and accordingly, the current flowing through the transistor 5 increases. The transistor 6 amplifies the current on the transistor 5 and transmits the amplified current to the charging controller 46 to rapidly increase the voltage at the node Nd and decrease the gate-source voltage of the transistor Q1, effectively limiting the current conducted to the output. Hence, the current through Q1 decreases and the charging current Ic on the branch 203 is constrained to the predetermined value. Therefore, the proposed current-limiting function is realized by a control circuit loop comprising the current detector 36, the current limiter 38, the charging controller 46, and the switch 32.

When the charging current is under the predetermined value, the difference the collector-emitter voltage of the transistor 14 and 15 are not large enough for the transistors 14 and 15 to conduct, such that the majority of the charging current flows through the branch 203. As the charging current Ic through the branch 203 increases, the transistors 5 and 6 conduct more current, and accordingly, the voltage at the node Nd increases. Therefore, the gate-source voltage of the transistor Q1 and the current flowing through the transistor Q1 both decrease, and consequently, the drain voltage of the transistor Q1 and the base voltage of the transistors 14 and 15 decrease. Therefore, when the current exceeds the predetermined value, the transistors 14 and 15 rapidly conduct currents on the branches 206 and 207, respectively. The overcurrent protector 40 starts to conduct the auxiliary current loc on the branch 205, which equals to the sum of the currents on the branch 206 and 207. Hence, the charging current Ic and auxiliary current loc can quickly burn the fuse 21 to achieve the proposed overcurrent protection. When the charging current is large enough to melt the transistor Q1, the thermo-coupled fuse 22 can also be burned at the same time to achieve auxiliary overcurrent protection.

The overvoltage protection mechanism is described in the following. In the voltage limiter 42, the Zener diode 2 and the resistor 3 establish a reference voltage at the gate of the transistor 1. When the voltage at the node Nb is within a normal operating range, the transistor 1 does not draw current, and thus does not establish a voltage at the resistor 8 of the auxiliary charging controller 48. Thus, the transistor Q2 functions normally, and the voltage at the node Nd is controlled by the current limiter 38. When the voltage at the node Nb exceeds the normal operating range, the transistor 1 starts to push current into the auxiliary control 48 and the charging controller 46. The voltage at the node Ne, i.e. the gate voltage of the transistor Q2, increases, thereby decreasing the gate-source voltage of the transistor Q2, and eventually turning off the transistor Q2. In the same manner, the voltage at the node Nd, i.e. the gate voltage of the transistor Q1, also increases, such that the gate-source voltage of the transistor Q1 decreases, and the transistor Q1 is turned off. Therefore, a voltage higher than the predetermined value at the node Nb is not transmitted to the output through the branches 203 and 205, and voltage-limiting protection is achieved.

For the embodiment shown in FIG. 2, the activation conditions and the response time of the overcurrent and overvoltage protection circuits can be easily modified by changing the circuit design parameters. For example, the activation condition and the sensitivity of the voltage-limiting protection circuit can be modified by changing the resistance of the resistor 3 and/or changing the breakdown voltage of the Zener diode 2. The response time of the current limiter 38 is characterized by the resistance of the resistors 11-13 and/or the driving capability of the transistors 5 and 6. By changing the value of the resistor 16 and/or the diode 17, the time delay when the overcurrent protection turns on can be modified. Improving the drive capability of the transistors 14 and 15 and/or adding more controlled current sources can also speed up the response time of the overcurrent protection mechanism. For instance, the controlled current sources in the overcurrent protector 40 can be replaced with other kinds of controlled current sources or current mirrors. The voltage limiter 42 can also be realized with a comparator and a controlled current source. The current limiter 38 can also be regarded as a controlled current source and thus is interchangeable with the current source structure in the overcurrent protector 40. Based on the above descriptions, the diagram in FIG. 2 is one of the possible embodiments of FIG. 1 and can be easily modified to apply to many electronic devices.

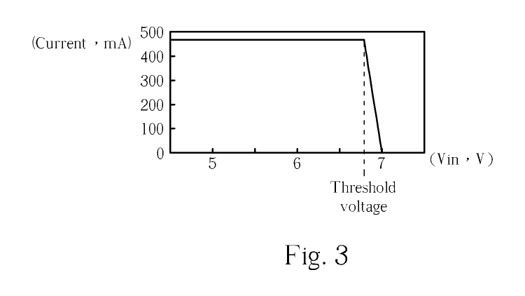

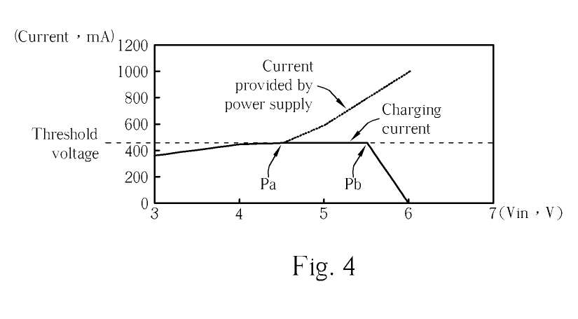

Please refer to FIG. 2, FIG. 3, and FIG. 4. FIG. 3 is an IV (current-voltage) plot of the overvoltage protection response of the circuit in FIG. 2. In FIG. 2, when the input voltage Vin exceeds the predetermined value, the transistors 1 and 2 stop conducting and disconnect the battery from the power supply for overvoltage protection. In FIG. 4, when the charging current approaches or exceeds the predetermined value at the point Pa, the current-limiting protection turns on and the charging current is maintained at a fixed value. When the current increases to the point Pb, the overcurrent protection turns on and melts down the fuse 21 to quickly disconnect the battery from the power supply.

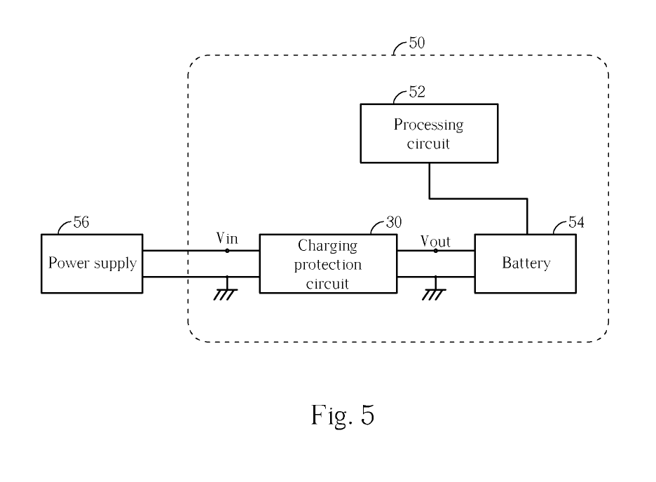

Please refer to FIG. 1, FIG. 2, and FIG. 5. FIG.5 is a diagram in which the charging protection circuit 30 is used in an electronic device 50. A processing circuit 52 controls the operations of the electronic device 50 and a battery 54 is used to store power for the processing circuit 52. The charging protection circuit 30 can be installed at the input end of the battery 54. In the charging process, the charging protection circuit 30 is coupled to a power supply 56 and the battery 54 to provide the current-limiting, overcurrent, and overvoltage protections. The electronic device 50 can be a mobile phone. The processing circuit can include antennas, wireless communication circuits, microphones, speakers, man-machine interfaces, microprocessors, memories, and so on. The electronic device 50 can also be a digital camera, a PDA, a portable computer, a portable media player, etc.

In conclusion, compared to the known techniques of the prior art, the present invention can realize an electronic-circuit-based overcurrent protection mechanism to supplement a fuse, providing high sensitivity, a fast response, and a robust charging protection mechanism both for electronic devices and users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging protection circuit comprising:
a fuse with a first end and a second end, the first end being coupled to a power supply for receiving a current from the power supply and the second end transmitting the current;
an output end coupled to the second end of the fuse for outputting the current transmitted from the power supply; and
an over-current protector coupled to the second end of the fuse for increasing a current load of the fuse in order to burn down the fuse when the current at the second end is greater than a predetermined value.

2. The charging protection circuit of claim 1 further comprising a switch coupled to the output end, to the second end of the fuse, and to the over-current protector, the switch receiving the current transmitted to the output and having a status responsive to the current, wherein the switch drives the over-current protector to increase the current load of the fuse when the status is responsive to the current greater than a predetermined value.

3. The charging protection circuit of claim 2 wherein the switch comprises a Metal-Oxide-Semiconductor (MOS) transistor having a source coupled to the second end of the fuse, and a drain coupled to the output end and the over-current protector.

4. The charging protection circuit of claim 3 wherein the over-current protector comprises a bipolarjunction transistor (BJT) having a base coupled to the drain of the MOS transistor.

5. The charging protection circuit of claim 2 further comprising:
a charging controller coupled to a gate of the MOS transistor;
a current detector coupled to the second end of the fuse and the output end for detecting current transmitted to the output end so as to generate detecting signals; and
a current limiter coupled to the current detector and to the charging controller for transferring detecting signals generated by the current detector.

6. The charging protection circuit of claim 5 wherein the switch comprises a MOS transistor having a source coupled to the second end of the fuse, a drain coupled to the output end, and a drain coupled to the charging controller.

7. The charging protection circuit of claim 6 wherein the current detector comprises a resistor coupled to the second end of the fuse and the output end, and the current limiter comprises a BJT transistor having a base coupled to a first end of the resistor and an emitter coupled to a second end of the resistors for conducting a current proportional to a current flowing from the second end of the fuse towards the output end.

8. The charging protection circuit of claim 6 wherein the charging controller comprises a resistor and a capacitor coupled to the switch for giving the switch a voltage.

9. The charging protection circuit of claim 2 further comprising:
a voltage limiter coupled to the second end of the fuse for detecting a voltage at the second end of the fuse; and
a charging controller coupled to the voltage limiter and the switch, for decreasing the current between the second end of the fuse and the output end when the voltage at the second end of the fuse is greater than a predetermined value.

10. The charging protection circuit of claim 9 further comprising:
an auxiliary switch coupled between the second end of the fuse and the over-current protector;
an auxiliary charging controller coupled to the voltage limiter and the auxiliary switch for decreasing a current between the second end of the fuse and the auxiliary switch when the voltage of the second end of the fuse is greater than a predetermined value.

11. The charging protection circuit of claim 10 wherein the auxiliary charging controller comprises a resistor coupled to the voltage limiter for generating an auxiliary voltage-limiting signal according a detection signal from the voltage limiter, and the auxiliary switch comprises a MOS transistor having a source coupled to the second end of the fuse, a drain coupled to the over-current protector, and a gate coupled to the resistor of auxiliary charging controller.

12. The charging protection circuit of claim 2 comprising an auxiliary fuse coupled between the switch and the output end.

13. The charging protection circuit of claim 12 wherein the auxiliary fuse is thermo-coupled to the switch for accelerating heating of the auxiliary fuse when the current flowing through the switch increases.

14. The charging protection circuit of claim 1 wherein the output is used for charging a battery.

15. The charging protection circuit of claim 14 being installed in an electronic device wherein the battery is used for providing power to the electronic device.

16. The charging protection circuit of claim 15 wherein the electronic device is a mobile phone.
